(19) United States
(12) Patent Application Publication
(10) Pub. No.: US 2025/0069764 A1
(43) Pub. Date: Feb. 27, 2025

(54) METHOD AND APPARATUS FOR REDUCING DETERIORATION IN A NUCLEAR REACTOR

(71) Applicant: Laura Holewa, Bluffton, SC (US)

(72) Inventor: Laura Holewa, Bluffton, SC (US)

(21) Appl. No.: 18/940,812

(22) Filed: Nov. 7, 2024

Related U.S. Application Data
(63) Continuation-in-part of application No. PCT/US2023/020493, filed on Apr. 28, 2023.
(60) Provisional application No. 63/342,051, filed on May 13, 2022.

(51) Int. Cl. G21C 19/28; F16L 58/02

(52) U.S. Cl. CPC G21C 19/28; F16L 58/02

(57) ABSTRACT

A method is described to reduce wear on the internal surface of a conduit in a closed-loop fluid system that transports corrosive nuclear material within a nuclear reactor. The method involves injecting two fluids into the conduit: a protective void fluid and a second fluid carrying the nuclear material. The nuclear material-containing fluid flows centrally in a laminar pattern, while the void fluid forms a protective layer around it, preventing direct contact with the conduit walls. By carefully controlling the injection and separation of these fluids, the nuclear material remains isolated from the conduit's surface, effectively limiting corrosion. This design prolongs the conduit's lifespan and enhances the system's efficiency by reducing surface degradation.

### CROSS-REFERENCE DATA

This patent application is a continuation-in-part of the International Patent Application No. PCT/US2023/020493 filed on 28 Apr. 2023 with the same title and by the same inventor, which, in turn, claims a priority from a U.S. Provisional Patent Application No. 63/342,051 filed on 13 May 2022, all of which are incorporated herein in their respective entireties by reference.

### TECHNICAL FIELD

This invention generally relates to a method and apparatus for reducing the deterioration in a nuclear reactor from nuclear materials during operation thereof.

### BACKGROUND

A self-sustaining nuclear reaction in nuclear fuel within a reactor core can be used to generate heat and electrical power. Nuclear reactors represent an appealing alternative to fossil fuels for generating power as a solution to the world's energy challenge. Operating nuclear plants for a long time in a safe and cost-effective manner is critical to their acceptance. To fulfill such a task, the aging and degradation of materials, components, and structures must be minimized.

Nuclear power plants have suffered various failures due to corrosion since the 1970s, costing the industry billions of dollars. By design, supposedly highly corrosion-resistant alloys have been used, such as Ni-based alloys, stainless steels, and Zr alloys. However, the field is rich with examples of corrosion failures of these alloys. Thus, it is desirable to have a solution that may ameliorate this corrosion through an alternative method.

Developmental nuclear reactors, such as the Gen IV that are being designed by companies now are considering or would like to consider the use of highly corrosive substances either as the moderator, the fuel, the coolant (which is sometimes combined with the moderator or the fuel) or for some combination or all of these. Such corrosive nuclear materials may include NaOH, NaK, FLiBc, FLiNaK, and other nuclear materials.

The conventional method to combat the deteriorative effects of these corrosive chemicals includes constructing the components that are subject to deterioration of supposedly highly corrosion-resistant alloys, such as Ni-Based alloys, stainless steels, and Zr alloys. For example, the practice of making pipes of Hastelloy-N with a Ni coating. However, it is unknown to what extent corrosion will occur in specific reactor designs until they are built, because the relevant conditions cannot be fully replicated without a full-scale model.

The components of a nuclear reactor subjected to corrosive materials often experience at least one type of corrosion-based deterioration, including stress corrosion cracking, irradiation-assisted stress corrosion cracking, environmentally assisted cracking, intergranular attack, flow-assisted corrosion, or general corrosion. In specific types of nuclear reactors, such as molten salt reactors, corrosion concerns exist due to the exceptionally caustic nature of the substances used.

In specific types of corrosion, the material may further become susceptible resulting from embrittlement. Embrittlement is a process that can also lead to the degradation of reactor structural components independently of corrosion. For instance, embrittlement processes in a molten salt nuclear reactor include tellurium embrittlement and helium embrittlement.

Aside from corrosion due to chemical interactions, damage to the internal components of nuclear reactors may result from harmful mechanical interactions. Flow-assisted corrosion is generally attributed to the presence of flow with high velocities in droplet impingement, and sometimes to the presence of abrasive magnetite particles. The consequence of this type of corrosion is wall thinning which can lead to a pipe leak or burst if not properly monitored or managed.

This background information is provided for information purposes only. No admission is intended, nor should it be construed, that any of the preceding information constitutes prior art against the present invention. In addition, the preceding information should not be construed to mean that a search has been made or that no other pertinent information as defined in 37 CFR § 1.56 (a) exists.

### SUMMARY

The present disclosure provides a method and apparatus for operating a nuclear reactor that uses jets of nuclear fluid separated by an inert gas annular boundary layer to protect interior surfaces inside the fluid conduits from deterioration and corrosion. Without wishing to be bound by any particular theory, it is believed that the separation of the corrosive or embrittling materials from the susceptible surfaces by transporting the corrosive or embrittling materials in the form of a jet through such surfaces while being surrounded by an annular boundary layer of inert gas will prevent undesirable deterioration by way of preventing the interaction of the materials.

It is well known by those skilled in the art that there are concerns regarding corrosion and embrittlement in specific nuclear reactor types, such as the molten salt nuclear reactor. It is further desired that nuclear reactors may function in such a way that is not expensive and does not require the use of rare materials.

The inventor discovered a system for transporting the nuclear moderator, coolant, or fuel throughout the core through the pipes and conduits of the closed-loop circulation system by way of forming jets. The jets are formed in a manner so that the nuclear moderator, fuel, or coolant would not directly contact the surface of such conduits. In other words, the jets may be configured so that the fluid will come proximal to the conduits it passes through without directly contacting the interior surface thereof. In some embodiments, an annular gas boundary layer comprising an inert gas, such as helium, is used to fill the space between the interior surface of the conduit and the nuclear fluid jet. An inert gas that becomes mixed with the jet of nuclear material may be separated thereafter and recirculated again. It is further envisioned that the liquid that is transported by the jets can also be used as a motive force to cause the liquid to navigate the fluid circulation system. Outside of the core, the jet transported moderator or fuel or coolant would come back into contact with other conduits of the fluid circulation system.

In embodiments, one method for reducing deterioration of an interior surface of a conduit that forms a part of a closed-loop fluid circulation system configured to circulate a nuclear material during an operation of a nuclear reactor, may include the following steps:
(a) injecting into the conduit a first void fluid through a first opening;
(b) injecting into the conduit and along thereof a second fluid comprising the nuclear material through a second opening; wherein the injecting of the second fluid through a nozzle is done to accomplish as follows:
   i. form a laminar flow of the second fluid proceeding along a central portion of a cross-sectional area of the conduit, and
   ii. form an annular boundary layer of the first void fluid in a peripheral portion of the cross-sectional area of the conduit adjacent to the internal surface thereof, thereby isolating the second fluid from the internal surface of the conduit;
(c) separating the first fluid from the second fluid; and
(d) recirculating the first fluid separated in step (c) for injecting back into the first opening.

Simultaneous injection of both fluids in the above-described method may be preferred unless design changes in the nuclear reactor's fluid circulation system are implemented to support other injection timing processes.

A further aspect of the invention pertains to a nuclear reactor comprising a closed-loop fluid circulation system, in turn, comprising a multiplicity of conduits. At least one nozzle may be disposed within at least one conduit, so that one or more nozzles are configured for modifying a flow of a nuclear material and forming a jet thereof. The nuclear reactor may further include at least one pump for fluid circulation within the closed-loop circulation system, an injector of gas into at least one conduit, a means for redirecting said nuclear material jet, a gas separator for removing admixed gas, and a means for reintroducing removed gas. The injector of gas is configured for injecting gas into at least one conduit to surround said nuclear material jet, thereby forming an annular boundary layer in a peripheral portion of the conduit and isolating the jet of nuclear material therefrom.

### BRIEF DESCRIPTION OF THE DRAWINGS

FIG. 1 is a cross-sectional view of one embodiment of a reactor according to the present disclosure.

FIG. 2 is an alternate cross-sectional view of an alternate embodiment of a reactor of the present disclosure.

FIG. 3 is a plan view of a molten salt reactor.

FIG. 4 is a schematic view of a nuclear material jet, as described herein.

FIG. 5 is a plan view of an embodiment of the reactor according to the present disclosure.

FIG. 6 is a schematic view of an arrangement of nuclear material jets according to the present disclosure.

FIG. 7 is a plan view of an alternate embodiment of the reactor according to the present disclosure.

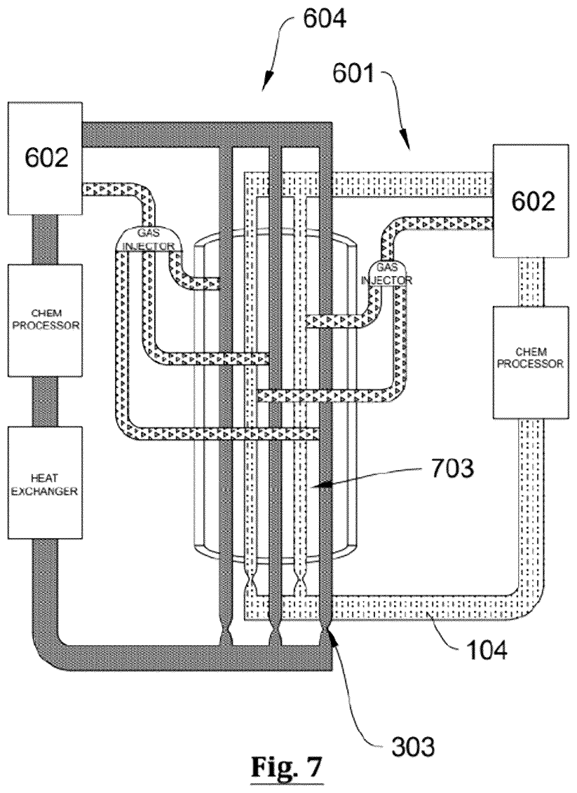

### DETAILED DESCRIPTION

Definitions. For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a +10% variation from the nominal value. It is to be understood that such a variation is always included in any given value provided herein, whether or not it is specifically referred to.

As used herein, the term “nuclear material” refers to a fluid that is employed in the operation of a nuclear reactor, for example, nuclear fuel, nuclear moderator, coolant, solutions of nuclear fuel, solutions of nuclear moderator, materials containing fissile isotopes, etc. Materials containing fissile isotopes include inorganic salts of uranium that have been enriched in uranium-235 and the like. In some embodiments, “nuclear material” may refer to a liquid or a gas.

As used herein, the term “fluid” refers to a liquid, gas, or other material that continuously deforms under an applied shear stress, or external force.

As used herein, the term “moderator” refers to a substance that is used to reduce the energy of neutrons in a reactor. In certain embodiments, the moderator and the coolant are the same.

As used herein, the term “void” refers to a space defined as a space having a separation of nuclear material and reactor surfaces.

As used herein, the term “jets” refers to a kinetic fluid having some momentum whose flow may be described by either turbulent or laminar flow.

As used herein, the term “injected” refers to the forceful introduction of some material to an environment.

As used herein, the term “motive fluid” refers to a fluid whose momentum is known and used for influencing the momentum of another fluid or directing the fluid to navigate certain passages. In some embodiments, the term may refer to a liquid or a gas.

As used herein, the term “void fluid” refers to any gas or liquid used to separate the jets of fluid containing nuclear material from the reactor wall. In some embodiments, these fluids would be inert or unreactive. In some embodiments, the term may refer to a liquid or a gas.

As used herein, the term “nuclear reactor” generally refers to an apparatus that comprises as its principal chain fission reacting medium, a material composed of a fissionable material disposed in an amassment, and adapted to engage, while so disposed, and spontaneous, self-sustaining chain fission reaction.

As used herein, the term “contaminated” generally refers to a substance that includes at least one foreign substance. Examples include a shield gas that has been admixed with nuclear material.

As used herein, the term “injection” generally refers to the introduction of a substance by means of a pump and an injector apparatus.

As used herein, the term “heading” generally refers to the vector of the momentum a fluid has acquired resulting from pressure acting thereon.

As used herein, the term “streams” generally refers to a quantity of fluid moving according to a convenient imaginary line defining a flow pattern.

As used herein, the term “gas shield” generally refers to a boundary layer of gas that displaces one material from another.

As used herein, the term “core” generally refers to a nuclear reactor core wherein the core is the portion of the reactor where the vast majority of nuclear fissions takes place and heat is generated.

As used herein, the term “cross flow” generally refers to a fluid that has flow normal to another fluid, objects, or groups of objects.

The present disclosure generally relates to improved methods and devices for the reduction of deterioration of a nuclear reactor. In some embodiments, the devices and methods of the present disclosure utilize nonreactive fluid to displace reactive substances from corrosives or deteriorators to reduce the destructive reactions that would otherwise occur. The methods of the present disclosure are particularly useful for the reduction of deterioration of a nuclear reactor.

Advantageously, in some embodiments, the devices and methods of the present disclosure include features that permit the nuclear materials to exist within the core of a nuclear reactor without contacting reactive walls or interior surfaces of the conduits. Moreover, the device and methods optionally employ advanced techniques to increase the safety and longevity of nuclear reactors during operation thereof. This aspect permits a more reliable generation of energy.

In one aspect, the present disclosure provides a method for reducing the deterioration (e.g., corrosion or embrittlement) from nuclear materials within a nuclear reactor.

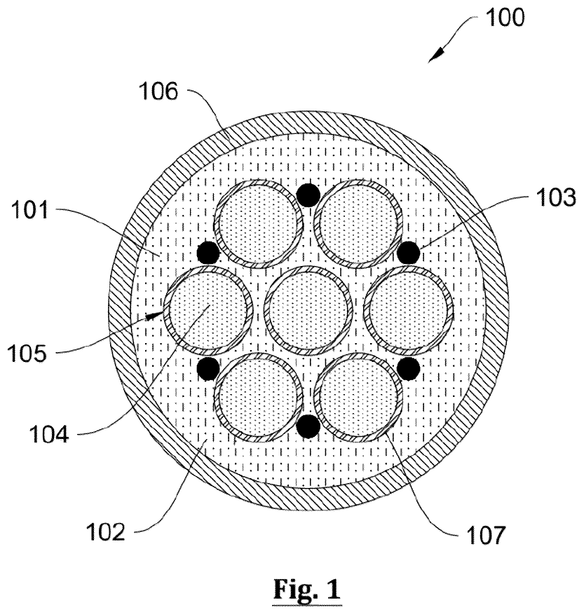

FIG. 1 shows a cross-section of one embodiment of a nuclear reactor core 100 according to the present disclosure. The method includes pumping a nuclear material (e.g., fissile nuclear fuel) 104 through a nuclear reactor core 100 wherein the reaction is moderated by a plurality of control rods 103, moderator material 102, and neutron reflectors 101. The nuclear material 104 can then be shielded by the introduction of a first void fluid 105 that separates the nuclear material 104 from the reactor conduits 107 or reactor wall 106. By way of displacing the corrosive material away from the conduits, the corrosive effects may be reduced.

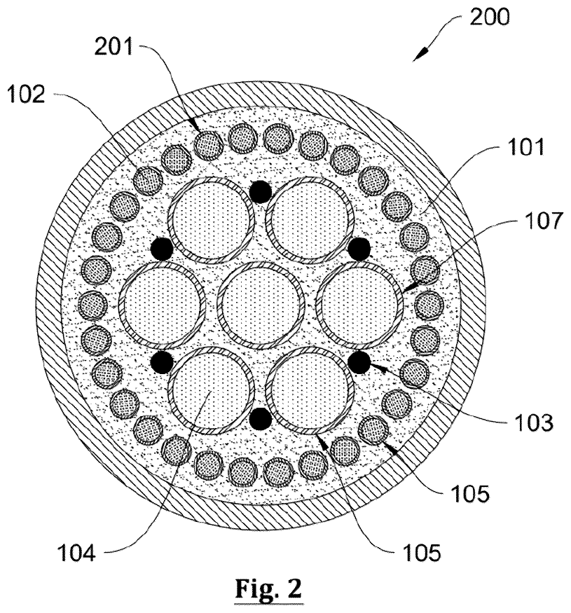

FIG. 2. shows an alternative arrangement of a nuclear reactor 200 described herein. The jets of nuclear material 104, in this case, contain a moderator 102 and are used as a neutron reflector 201 about the perimeter of the reactor. In some embodiments, the method may include separating the moderator or the void fluid after the introduction of the fluid to the reactor to reduce contamination.

In some embodiments, it is envisioned that the first void fluid 105 may comprise an inert gas that does not react with the corrosive materials of the reactor. In some embodiments, it is desirable that the void fluid 105 will create an annular fluid shield that resists deformation by jets of nuclear material 104. In further embodiments, the nuclear material 104 may be, but is not limited to, a neutron moderator or a fuel/moderator mix that acts or contains a coolant.

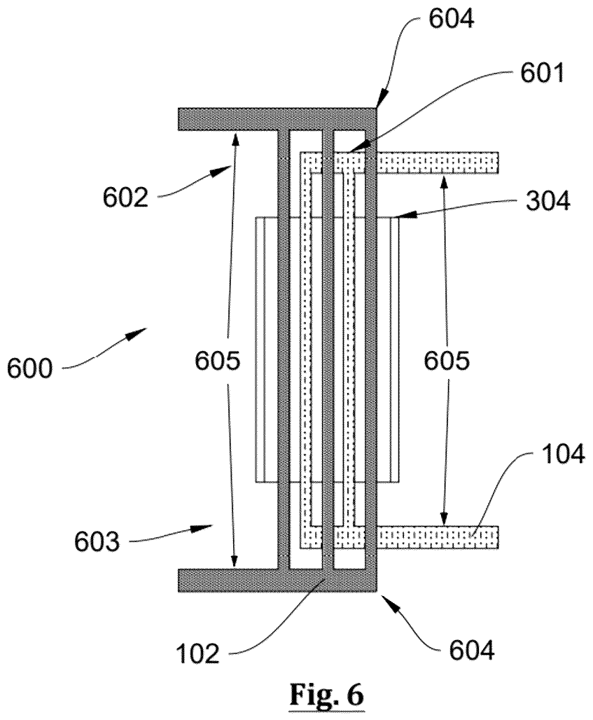

Turning now to FIG. 6, an arrangement of nozzles for introducing the first void fluid 104 and the second fluid containing the nuclear material is described. The moderator may be introduced upwardly, downwardly, or a combination of upwardly and downwardly directions. In a similar fashion, the nuclear material may be introduced upwardly, downwardly, or in a combination of both directions. In some embodiments, fluid flow in the upper gallery 602 or the lower gallery 603 may be redirected through interaction with another fluid's momentum or by becoming a motive fluid. In another possible arrangement, the fluid is urged to make a 90-degree turn 604 by either a pressure applied by a pump, a driving force from a motive fluid, or by physical barriers disposed within the conduits 107 of the fluid circulation system.

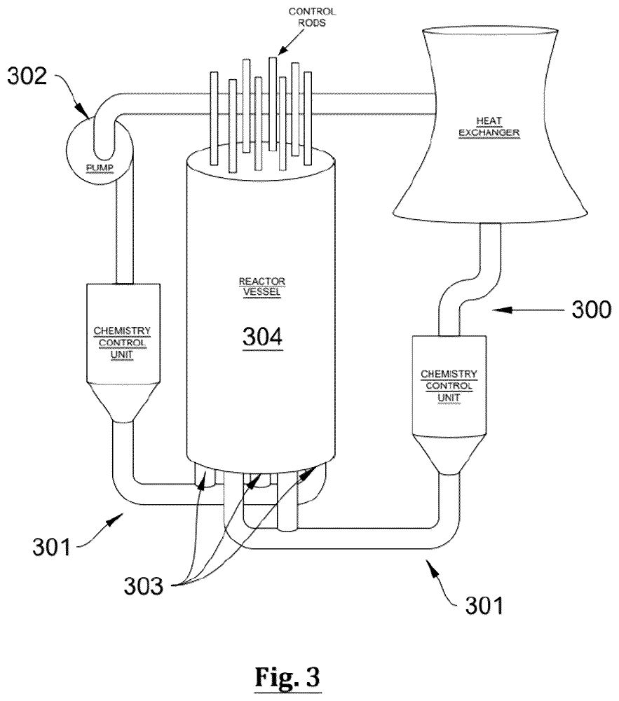

In another aspect, the present disclosure is illustrated in FIG. 3 and describes a nuclear reactor 300 having a plurality of conduits 301 in mutual fluid communication for introducing nuclear material thereto, the reactor includes a pump 302 for providing a pressure head to said nuclear material. The reactor 300 includes at least one nozzle 303 within the conduits 301. At least one nozzle 303 is configured to form a jet of a nuclear material. The nuclear material may then be transported throughout the reaction vessel 304. The jets of nuclear material may be arranged to form a void space within the conduits that may be filled with a void fluid that displaces the reactive nuclear material away from the wall of the conduit.

Turning now to FIG. 6, an alternate embodiment of a nuclear reactor 600 as disclosed herein is described. In some embodiments, the second fluid being circulated throughout the reactor may be a motive fluid 601 which supplies the driving means for the fluid throughout the reactor. In some embodiments, a gas separator 602 may be introduced into the closed fluid circulation system 605 to separate admixed void fluid from nuclear material such that it may be later recirculated and reintroduced.

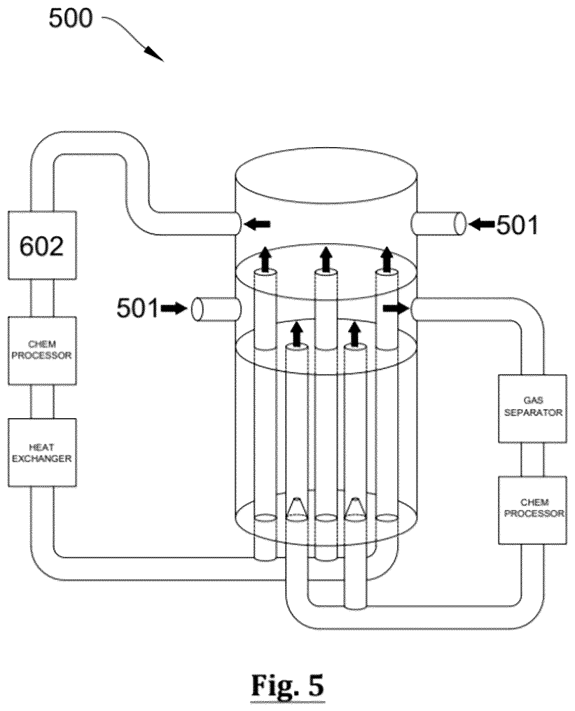

FIG. 5 shows a schematic view of another embodiment of a nuclear reactor 500 as described herein. In such an embodiment, a gas separator 602 is situated in the fluid circulation system to remove contaminants from the annular gas shield. Further described in FIG. 5 is motive fluid 501, the laminar flow of which defines a momentum that causes the fluid to navigate through the fluid circulation system of the reactor. The momentum of the second fluid flow may be sufficient to influence the momentum of a first void fluid having interaction therewith-so as to form an annular barrier of the first void fluid and separate the second fluid from the internal surfaces of the conduit. Further, the second motive fluid is envisioned to have the momentum to navigate through the fluid circulation system which may have baffles, barriers, angles 604, high friction segments, or the like. It is envisioned that a motive fluid may be used to control the fluid flow of the nuclear reactor.

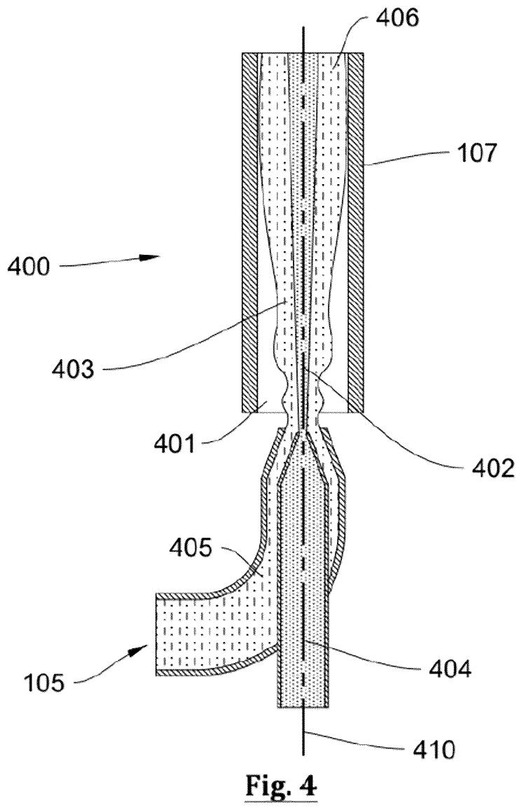

FIG. 4 shows a detailed image of the nuclear material jet arrangement 400 as described herein. The nuclear material jet arrangement comprises a nozzle assembly 404 situated proximal to a reactor core conduit opening 401. The nozzle 404 is configured to supply a jet of nuclear material 402 which is characterized by laminar flow inside the conduit. Further, the jet is configured to follow the central axis 407 of the conduit. Simultaneous with the injection of the second fluid containing a nuclear material, a fluid injector 406 injects a first void fluid that projects into an annular boundary layer forming an annular shield 406 having a tubular shape centered about and surrounding the jet of nuclear material in the center. This shield may, at least in some cases, be impermeable and may separate the reactor wall and nuclear material.

### LIST OF EMBODIMENTS

Embodiment 1. A method for reducing deterioration of an interior surface of a conduit that forms a part of a closed-loop fluid circulation system configured to circulate a nuclear material during an operation of a nuclear reactor, may include the following steps:
(a) injecting into the conduit a first void fluid through a first opening;
(b) injecting into the conduit and along thereof a second fluid comprising the nuclear material through a second opening; wherein the injecting of the second fluid through a nozzle is done to accomplish as follows:
   iii. form a laminar flow of the second fluid proceeding along a central portion of a cross-sectional area of the conduit, and
   iv. form an annular boundary layer of the first void fluid in a peripheral portion of the cross-sectional area of the conduit adjacent to the internal surface thereof, thereby isolating the second fluid from the internal surface of the conduit;
(c) separating the first fluid from the second fluid; and
(d) recirculating the first fluid separated in step (c) for injecting back into the first opening.

Embodiment 2. The method of Embodiment 1, wherein said deterioration is embrittlement or corrosion.

Embodiment 3. The method of Embodiment 1, wherein said void fluid is a fluid having little to no reactivity.

Embodiment 4. The method of Embodiment 1, wherein the void fluid comprises an inert gas, such as helium.

Embodiment 5. The method of Embodiment 1, wherein said nuclear material comprises a neutron moderator, such as NaOH.

Embodiment 6. The method of Embodiment 1, wherein said nuclear material comprises a fluid containing coolant.

Embodiment 7. The method of Embodiment 1, wherein said nuclear material comprises a fluid containing nuclear fuel, such as an inorganic salt of uranium that is highly isotopically enriched in uranium-235.

Embodiment 8. The method of Embodiment 1, wherein the step (b) of injecting said second fluid from the nozzle is done to form a laminar flow jet with momentum sufficient to form said annular boundary layer of the first void fluid in a peripheral portion of the cross-sectional area of the conduit with sufficient annular layer thickness to effectively separate the second fluid from the conduit.

Embodiment 9. The method of claim 8, wherein the momentum of the jet emanating from said nozzle is sufficient to flow said second fluid through the conduit of said closed-loop circulation system in fluid communication therewith.

Embodiment 10. The method of claim 1, wherein said annular boundary layer in step (b) has a thickness sufficient to prevent chemical reactions of said second fluid and said conduit.

Embodiment 11. The method of Embodiment 1, wherein said fluid leaving said jets has a heading collides with another fluid at an angle such that the resulting stream continues in said heading.

Embodiment 12. The method of Embodiment 1, wherein said void fluid forms a boundary layer of a thickness sufficient to reduce or prevent chemical reactions of said second fluid flow and said wall or interior surface of the conduit.

Embodiment 13. The method of Embodiment 1, wherein said nozzles project said jets coincidental with a direction of gravitational pull.

Embodiment 14. The method of Embodiment 1, wherein said nozzles project said jets against the gravitational pull.

Embodiment 15. The method of Embodiment 1, wherein said nozzles project said jets both along with and against the gravitational pull.

Embodiment 16. The method of Embodiment 1, wherein the first and second fluids define a fluid flow that is redirected by at least one barrier to control fluid flow direction.

Embodiment 17. The method of Embodiment 1, wherein the first and second fluids define a fluid flow that is redirected by at least one barrier to control fluid flow direction.

Embodiment 18. The method of Embodiment 1, wherein the first fluid is immiscible in the second fluid.

Embodiment 19. The method of Embodiment 1, wherein said first opening and said second opening form nested openings.

Embodiment 20. A nuclear reactor comprising:
a closed-loop fluid circulation system comprising a multiplicity of conduits;
at least one nozzle disposed within at least one conduit, the at least one nozzle is configured for modifying a flow of a nuclear material and forming a jet thereof;
at least one pump for fluid circulation within the closed-loop circulation system;
an injector of gas into at least one conduit;
a means for redirecting said nuclear material jet;
a gas separator for removing admixed gas;
a means for reintroducing removed gas;
wherein the injector of gas is configured for injecting gas into at least one conduit to surround said nuclear material jet, thereby forming an annular boundary layer in a peripheral portion of the conduit and isolating the jet of nuclear material therefrom.

Embodiment 21. The reactor of Embodiment 20, wherein said nuclear material comprises a fluid containing nuclear fuel.

Embodiment 22. The reactor of Embodiment 20, wherein said jet of nuclear material is defined by laminar flow.

Embodiment 23. The nuclear reactor of claim 20, wherein said nozzle is configured to establish the jet of nuclear material and form the annular boundary layer as an annular gas shield to protect an interior surface of said at least one conduit from deterioration as a result of contact with the nuclear material of the jet.

Embodiment 24. The nuclear reactor of claim 23, wherein the thickness of said annular gas shield is at least a displacement thickness of a laminar regime of said inert gas.

Embodiment 25. The reactor of Embodiment 20, wherein said nuclear material is coolant.

Embodiment 26. The reactor of Embodiment 20, wherein shield fluid is an inert gas.

Embodiment 27. The reactor of Embodiment 20, wherein said nuclear material comprises a fluid nuclear moderator, such as NaOH.

Embodiment 28. The reactor of Embodiment 20, further comprising injectors configured such that the injected void fluid establishes a boundary shield layer around a central jet of nuclear material forming an annular shield between said conduits and said jets whose thickness forms a fluid boundary, that in some cases may be impermeable.

Embodiment 29. The reactor of Embodiment 20, wherein said nuclear material jet is provided with a momentum from said nozzle to be transported through the conduits whose orientation may vary at different angles and locations.

Embodiment 30. The reactor of Embodiment 20, further comprises means for exerting variable pressure on said nuclear material jet emitted from said nozzles and said gas.

Embodiment 31. The reactor of Embodiment 20, wherein said nuclear reactor is a molten-salt reactor.

Embodiment 32. The reactor of Embodiment 20, wherein said nuclear reactor is of the sodium-cooled fast-reactor type.

Embodiment 33. The reactor of Embodiment 20, wherein said nozzles are oriented such that the openings are downwardly facing providing gravity-assisted flow.

Embodiment 34. The reactor of Embodiment 20, wherein the means for redirecting said nuclear material includes at least one rigid, in some cases impermeable, boundary adapted to modify the fluid's heading.

Embodiment 35. The reactor of Embodiment 20, wherein the means for redirecting said nuclear material are configured to combine the momentum of intersecting fluids.

Embodiment 36. The reactor of Embodiment 20, wherein said nozzles are oriented such that the opening is upwardly facing relative to a floor.

Embodiment 37. The reactor of Embodiment 20, wherein said nozzles are oriented to provide cross-flow.

Embodiment 38. The reactor of Embodiment 20, wherein said inert gas is a noble gas, such as helium.

### EXAMPLE

The following describes one potential scenario for using the present invention. In a thermal spectrum liquid moderated molten salt reactor (which is one type of reactor that the method can be implemented in), conduits pass through the core. The thickness of the conduits of the fluid circulation system inside such a reactor must be thin, relative to the thickness of the conduits outside the core. This is because the conduits inside the core must not impede too significantly the process of fission from occurring. In a molten salt nuclear reactor, the second fluid containing a nuclear material must proceed along a closed-loop fluid circulation system. In such a system, there can be at least one vertical section or conduit in which the fluid with the nuclear material passes through in the form of a jet, and which resumes contact with the conduit walls after passing through the vertical section. The goal of the method in this example is to enable the nuclear material of the second fluid to pass through the conduits that must have relatively thin walls without contacting the walls and then be allowed to resume contact with conduits where the pipe walls can be relatively thick. This is because hazardous conditions will occur if even a small amount of corrosion or embrittlement occurs in the conduits with these thinner walls as compared to the conduits with thicker walls.

The break-up of a jet occurs when the continuous stream of liquid breaks into droplets, which happens when gravity and surface tension overcome inertial and viscous forces. If the described method is implemented in a molten salt reactor, then it is important that the jet of nuclear material does not break up while it passes through the core. The diameter of the droplets is larger than the diameter of the jet, so if the jet breaks into droplets, the droplets may touch the conduits. The length in a vertical conduit at which jet breakup occurs is called the breakup length.

The breakup length (L) is difficult to predict from theory alone. For a given liquid, if viscous forces are neglected an expression for L can be found that uses the Weber number and the Froude number. The Weber number expresses the ratio of inertial force to surface tension. The Froude number expresses the ratio of inertial force to gravity.

The velocity of the jet will increase as it passes through the core. A downward traveling direction is used so that the velocity of the jet increases as it travels and the increased inertia aids in preventing jet breakup. By knowing the entrance velocity, the approximate velocity of the jet at any point as it travels through the core can be found from basic kinematic equations.

The following was done to approximate a minimum breakup length of FLiBc (2LiF-BcF2 is a molten salt which may be mixed with uranium and/or thorium for use as a nuclear material in molten salt nuclear reactors) in a conduit in an exemplary thermal spectrum liquid moderated molten salt nuclear reactor. In this example, the FLiBe (unmixed with uranium or thorium) enters a conduit with a diameter of 10 cm, and with an entrance velocity of 1.2 m/s. The density of FLiBc at 566° C., 2.0 g/cm³ was used. The surface tension of 0.195 N/m was used, this is the surface tension of FLiBe at 566° C. (The temperature of 566° C. was chosen because that is the minimum temperature inside this hypothetical molten salt reactor.)

As the fuel salt heats up, its properties, such as density, surface tension, and viscosity, will substantially change. However, the breakup length will be lowest when the ratio of density to surface tension is lowest. For this example, this is assumed to occur when the temperature is also the lowest. It was found that the breakup length would be 197.3 cm. At this length, the jet will exit with a velocity of 6.3 m/s.

Nuclear material to be used in a molten salt reactor would have uranium or thorium in it as well. Fueled FLiBe molar compositions have been considered for use with a low percentage of UF4. For example, LiF-BeF2-UF4 with molar composition percentages: 62-37-1. The density of the fueled FLiBe would be higher than FLiBe on its own, contributing to a higher breakup length (a positive effect). The effect of adding UF4 on the surface tension is harder to predict, but regardless, a molar composition of fueled FLiBe with a low percentage of UF4 could be used such that the surface tension is not very different than the surface tension of FLiBe without uranium or thorium in it. It is therefore reasonable to assume that a jet of nuclear material can pass downward through 197.3 cm of conduit length, starting with a velocity of 1.2 m/s and ending with a velocity of 6.3 m/s.

Embodiments of the present disclosure are described herein, including the best mode known to the inventors for carrying out the invention. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the Embodiments appended hereto as permitted by applicable law. Moreover, any combination of the above-described elements in all possible variations thereof is encompassed by the invention unless otherwise indicated herein or otherwise clearly contradicted by context.

The above disclosure is intended to be illustrative and not exhaustive. This description will suggest many variations and alternatives to one of ordinary skill in this art. All these alternatives and variations are intended to be included within the scope of the Embodiments where the term “comprising” means “including, but not limited to.” Those familiar with the art may recognize other equivalents to the specific embodiments described herein which equivalents are also intended to be encompassed by the embodiments.

1. A method for reducing deterioration of an interior surface of a conduit that forms a part of a closed-loop fluid circulation system configured to circulate a nuclear material during an operation of a nuclear reactor, said method comprising:
(a) injecting into the conduit a first void fluid through a first opening;
(b) injecting into the conduit and along thereof a second fluid comprising the nuclear material through a second opening; wherein the injecting of the second fluid through a nozzle is done to accomplish as follows:
i. form a laminar flow of the second fluid proceeding along a central portion of a cross-sectional area of the conduit, and
ii. form an annular boundary layer of the first void fluid in a peripheral portion of the cross-sectional area of the conduit adjacent to the internal surface thereof, thereby isolating the second fluid from the internal surface of the conduit;
(c) separating the first fluid from the second fluid; and
(d) recirculating the first fluid separated in step (c) for injecting back into the first opening.

2. The method of claim 1, wherein said first opening and said second opening form nested openings.

3. The method of claim 1, wherein said void fluid has substantially no chemical reactivity.

4. The method of claim 1, wherein the void fluid is an inert gas.

5. The method of claim 1, wherein said nuclear material comprises a neutron moderator.

6. The method of claim 1, wherein said nuclear material comprises a fluid containing a coolant.

7. The method of claim 1, wherein said nuclear material comprises a fluid containing a nuclear fuel.

8. The method of claim 1, wherein the step (b) of injecting said second fluid from the nozzle is done to form a laminar flow jet with momentum sufficient to form said annular boundary layer of the first void fluid in a peripheral portion of the cross-sectional area of the conduit to effectively separate the second fluid from the conduit.

9. The method of claim 8, wherein the momentum of the jet emanating from said nozzle is sufficient to flow said second fluid through a core of the nuclear reactor.

10. The method of claim 1, wherein said annular boundary layer in step (b) has a thickness sufficient to prevent chemical reactions of said second fluid and said conduit.

11. The method of claim 8, wherein said nozzle project said jet coincidental with a gravitational pull.

12. The method of claim 1, wherein the first fluid and the second fluid define a fluid flow that is redirected by at least one barrier configured to control fluid flow direction.

13. The method of claim 1, wherein said first fluid and second fluid together define fluid flow that is controlled by interaction and conservation of fluid momentum.

14. A nuclear reactor comprising:
a closed-loop fluid circulation system comprising a multiplicity of conduits;
at least one nozzle disposed within at least one conduit, the at least one nozzle is configured for modifying a flow of a nuclear material and forming a jet thereof;
at least one pump for fluid circulation within the closed-loop circulation system;
an injector of gas into the at least one conduit;
a means for redirecting said nuclear material jet;
a gas separator for removing admixed gas;
a means for reintroducing removed gas;
wherein the injector of gas is configured for injecting gas into the at least one conduit to surround said nuclear material jet, thereby forming an annular boundary layer in a peripheral portion of the conduit and isolating the jet of nuclear material therefrom.

15. The nuclear reactor of claim 14, wherein said gas is an inert gas.

16. The nuclear reactor of claim 14, wherein said nuclear material comprises a molten salt.

17. The nuclear reactor of claim 14, wherein said nuclear material is a liquid nuclear moderator.

18. The nuclear reactor of claim 14, wherein said nuclear material contains a nuclear fuel.

19. The nuclear reactor of claim 14, wherein said nozzle is configured to establish the jet of nuclear material and form the annular boundary layer as an annular gas shield to protect an interior surface of said at least one conduit from deterioration as a result of contact with the nuclear material of the jet.

20. The nuclear reactor of claim 19, wherein the thickness of said annular gas shield is at least a displacement thickness of a laminar regime of said inert gas.
